(19) United States
(12) Patent Application Publication
(10) Pub. No.: US 2008/0111041 A1
(43) Pub. Date: May 15, 2008

(54) Garment hook

(76) Inventors: Errol Drew, Northampton (GB); Philip Justin Karl, Providence, RI (US)

Correspondence Address: David J. Rikkers;Foley & Lardner LLP, 111 Huntington Avenue, Boston, MA, 02199, US

(21) Appl. No.: 11/599,902

(22) Filed: Nov. 14, 2006

(51) Int. Cl. A47H 1/16; A47F 5/00; B23P 17/04; B21F 1/00

(52) U.S. Cl. 248/303; 248/309.1; 29/592; 29/34 D

(57) ABSTRACT

Methods and devices are provided for a garment hook including a base plate adapted to receive a fastener to secure the base plate to a wall. A top hook can be formed by a first loop of a wire and secured to the base plate, the top hook optionally extending upwardly at a first angle with respect to the base plate. The top hook can be adapted to receive a hat or garment. A bottom hook can be formed by a second loop of a wire and secured to the base plate, the bottom hook optionally extending horizontally from the base plate and then forming an upwardly and outwardly extending curved portion, extending outwardly at a second angle relative to the base plate, the curved portion optionally having a width dimension at least twice a width dimension of the top hook.

### BACKGROUND

The present invention relates generally to the field of hooks, and more specifically to garment hooks.

Hooks have long been used to hang coats and other garments. However, traditional hooks have a tendency to disfigure garments by creating an unsightly bulge in the garment that remains even after the garment is removed from the hook. This problem is sometimes overcome by the use of a hanger, whereby the garment is mounted on the hanger and then the hanger is hung on the hook. Other approaches involve equipping the garment with a small loop that hangs from the hook to minimize disfiguring of the fabric of the garment. Traditionally, some traditional hooks only provide a single hook for a user to hang both a garment and other articles of clothing, such as a hat.

There is a need in the art for a garment hook that can minimize disfigurement of garments and also provide a second hook upon which a hat or other article may be located.

### SUMMARY

Various embodiments of the present invention can address some of the deficiencies of the art. Examples of the present invention may be used in a wide variety of applications to provide a garment hook to hang one or more garments and/or hats.

Various embodiments of the invention may provide a garment hook. According to an illustrative embodiment of the invention, the garment hook includes: a base plate adapted to receive a fastener to secure the base plate to a wall; a top hook formed by a first loop of a wire and secured to the base plate, the top hook extending upwardly at a first angle with respect to the base plate, the top hook adapted to receive a hat or garment; and a bottom hook formed by a second loop of a wire and secured to the base plate, the bottom hook extending horizontally from the base plate and then forming an upwardly and outwardly extending curved portion, extending outwardly at a second angle relative to the base plate, the curved portion having a width dimension at least twice a width dimension of the top hook.

According to one illustrative embodiment of the invention, a garment hook includes: a base plate adapted to receive a fastener to secure the base plate to a wall; a top hook formed by a first loop of a wire and secured to the base plate, the top hook extending upwardly at a first angle with respect to the base plate, an end portion of the top hook forming an enlarged radius portion oriented at a second angle with respect to the base plate, the top hook adapted to receive a hat or garment; and a bottom hook formed by a second loop of a wire and secured to the base plate, the bottom hook forming a downwardly extending curved portion coupled to an upwardly extending curved portion, the curved portion having a width dimension at least twice a width dimension of the top hook.

In another illustrative embodiment of the invention, a method of manufacturing a garment hook includes providing a base plate adapted to receive a fastener to secure the base plate to a wall. Formed from a single wire are: a first loop forming a top hook extending upwardly at a first angle with respect to the base plate, the top hook adapted to receive a hat or garment; and a second loop forming a bottom hook extending horizontally from the base plate and then forming an upwardly and outwardly extending curved portion, extending outwardly at a second angle relative to the base plate, the curved portion having a width dimension at least twice a width dimension of the top hook. The single wire is attached to the base plate.

### BRIEF DESCRIPTION OF THE DRAWINGS

The invention will be apparent from the description herein and the accompanying drawings.

FIG. 1 is a perspective view of a garment hook according to a first illustrative embodiment of the invention;

FIG. 2 is a front view of a garment hook according to a first illustrative embodiment of the invention;

FIG. 3 is a side view of a garment hook according to a first illustrative embodiment of the invention;

FIG. 4 is a back view of a garment hook according to a first illustrative embodiment of the invention;

FIG. 5 is a top view of a garment hook according to a first illustrative embodiment of the invention;

FIG. 6 is a bottom view of a garment hook according to a first illustrative embodiment of the invention;

FIG. 7 is a perspective view of a garment hook with a cover according to a first illustrative embodiment of the invention;

FIG. 8 is a perspective view of a garment hook according to a second illustrative embodiment of the invention;

FIG. 9 is a front view of a garment hook according to a second illustrative embodiment of the invention;

FIG. 10 is a side view of a garment hook according to a second illustrative embodiment of the invention;

FIG. 11 is a back view of a garment hook according to a second illustrative embodiment of the invention;

FIG. 12 is a top view of a garment hook according to a second illustrative embodiment of the invention; and

FIG. 13 is a bottom view of a garment hook according to a second illustrative embodiment of the invention.

### DETAILED DESCRIPTION

According to various embodiments of the invention, methods and devices are provided for a garment hook that is configured so as to minimize disfigurement of garments.

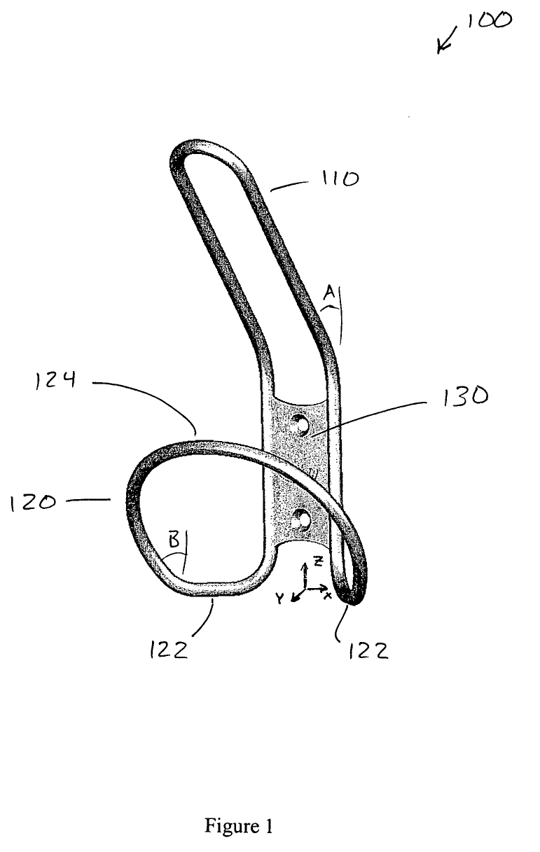

As illustrated in FIG. 1, an exemplary embodiment of a garment hook 100 is shown having a top hook 110 and a bottom hook 120. A base plate 130 is also provided and located between the top hook 110 and bottom hook 120. The base plate 130 is configured to receive one or more fasteners to secure the base plate 130 to a wall or other object, examples of which include a post and door. Examples of fasteners are widely known in the art and include screws, bolts, and nails.

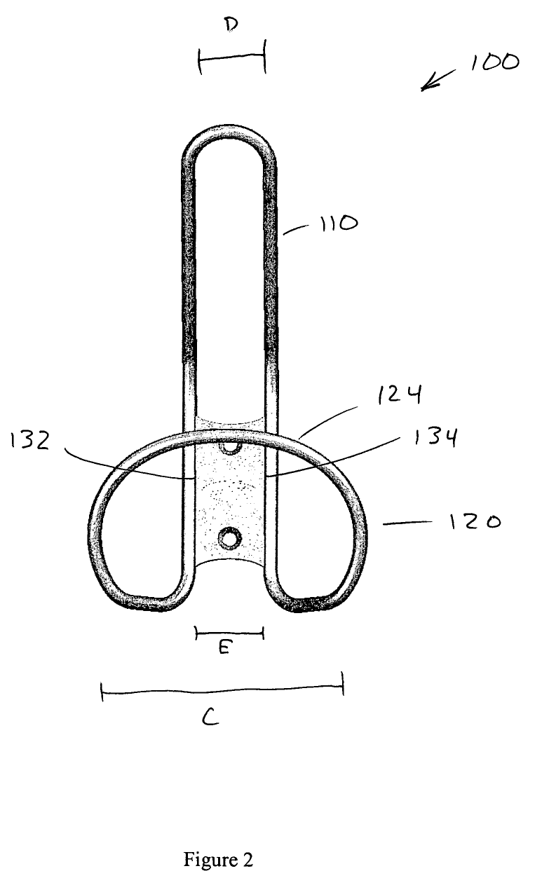

The top hook 110, according to the illustrative embodiment of FIG. 1, is formed by a first loop of a wire and extends upwardly at a first angle A with respect to the base plate. The top hook may be used to receive a hat or other garment. The top hook 110 is secured to the base plate 130. The bottom hook 120 is also secured to the base plate 130 and has portions 122 extending horizontally from the base plate and then forms an upwardly and outwardly extending curved portion 124. The portions 122 of the bottom hook 120 extend horizontally from the base plate 130 in both an X and a Y direction. The upwardly and outwardly extending curved portion 124 extends outwardly at a second angle B relative to the base plate. With reference to FIG. 2, the upwardly and outwardly extending curved portion 124 has a width dimension C at least twice a width dimension D of the top hook.

As illustrated in FIG. 2, the base plate 130 of the illustrative embodiment has a width E equal to the width D of the first loop. In the illustrative embodiment, the top hook 110 and bottom hook 120 may be formed of a single, continuous wire. The wire may include portions that are mounted to opposing edges 132, 134 of the base plate 130.

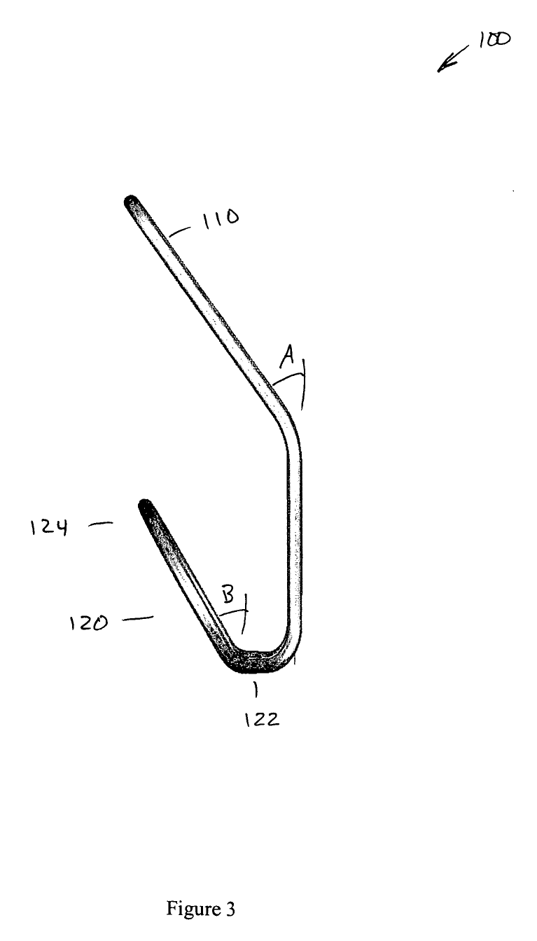

FIG. 3 illustrates the garment hook 100 from a side view. As illustrated in FIG. 3, the first angle A may be substantially equal to the second angle B. The portion of the top hook 110 extending upwardly at first angle A is longer than the upwardly and outwardly extending curved portion 124 of the bottom hook 120 and/or longer than the portion 122 of the bottom hook 120 extending horizontally from the base plate 130.

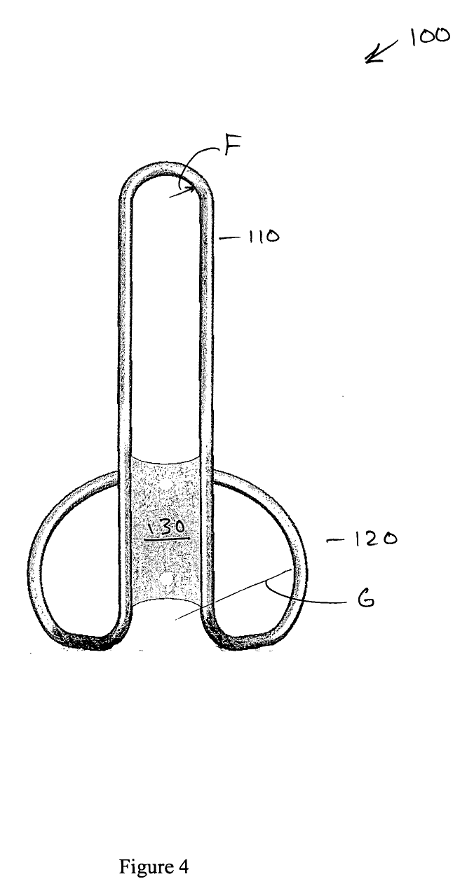

FIG. 4 illustrates a back view of the garment hook 100. A radius F of a portion of the top hook 100 extending upwardly at a first angle A is smaller than a radius G of the upwardly and outwardly extending curved portion 124 of the bottom hook 120.

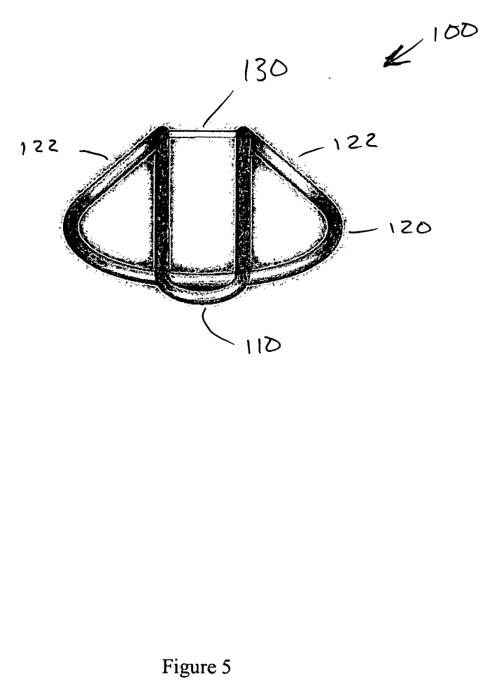

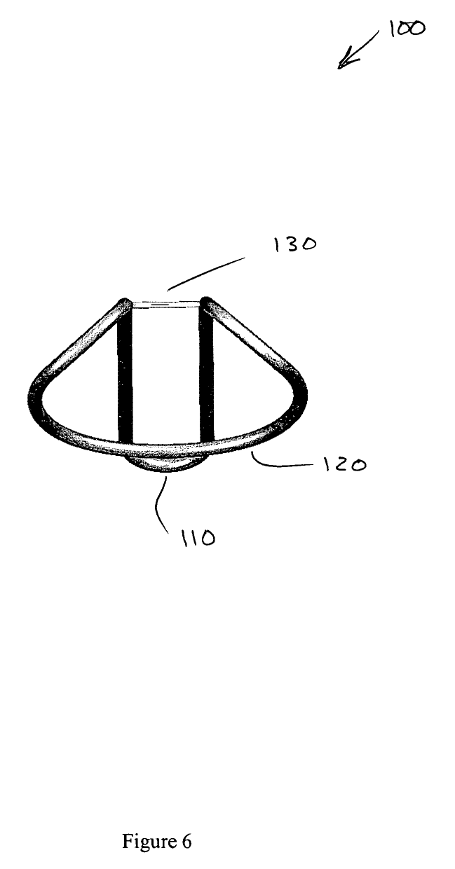

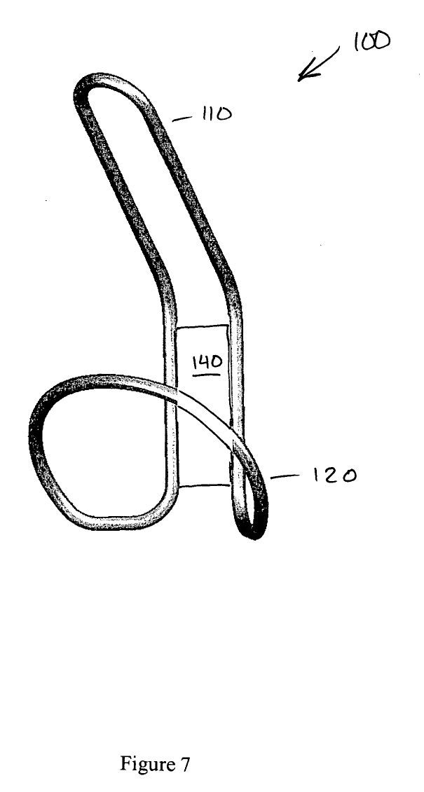

FIG. 5 illustrates a top view of the garment hook 110, and FIG. 6 illustrates a bottom view of the garment hook 100. FIG. 7 illustrates a cover 140 adapted to cover at least a portion of the base plate 130. According to the example embodiment, the cover 140 is configured to hide the portions of the base plate 130 adapted to receive fasteners. Therefore, the fasteners are hidden after the garment hook 100 has been mounted to a wall or other object. Examples of materials for the cover can include, but are not limited to, anodized aluminum and polished wood. The cover 140 may be attached to the base plate 130, top hook 110 and/or bottom hook 120 by the use of clips, adhesive or sizing of the cover 140 and neighboring components or components to enable the cover 140 to snap in place.

The approximate dimensions of the example embodiment of garment hook of FIGS. 1-7 are a center-to-center width of the bottom hook at 59 mm, with an outside width of 62 mm. The approximate top hook widths are 19 mm center-to-center and 22 mm outside width. An overall height is approximately 93 mm.

The top hook 110 and bottom hook 120 may be formed of a wide variety of materials. Examples of materials include stainless steel, aluminum, steel, plastic, and other materials of suitable strength for maintaining their shape while holding garments. The wire may be solid or hollow. In some implementations, the wire may be considered a tube or rod. The base plate 130 may be formed of a wide variety of materials including, for example, stainless steel, steel, aluminum, or plastic. The base plate 130 may be mounted to the top hook 110 and/or bottom hook 120 by the use of welds or glues or other methods of securing objects together. Alternatively, the garment hook 100 may be formed by casting, including, optionally, the casting of the top hook 110, base plate 130 and the bottom hook 120 as a single casting. In one example, the single, continuous loop of wire for the garment hook 100 is formed from a wire formed into a loop by joining the ends of the wire and then the loop is stamped to more accurately form the desired shape.

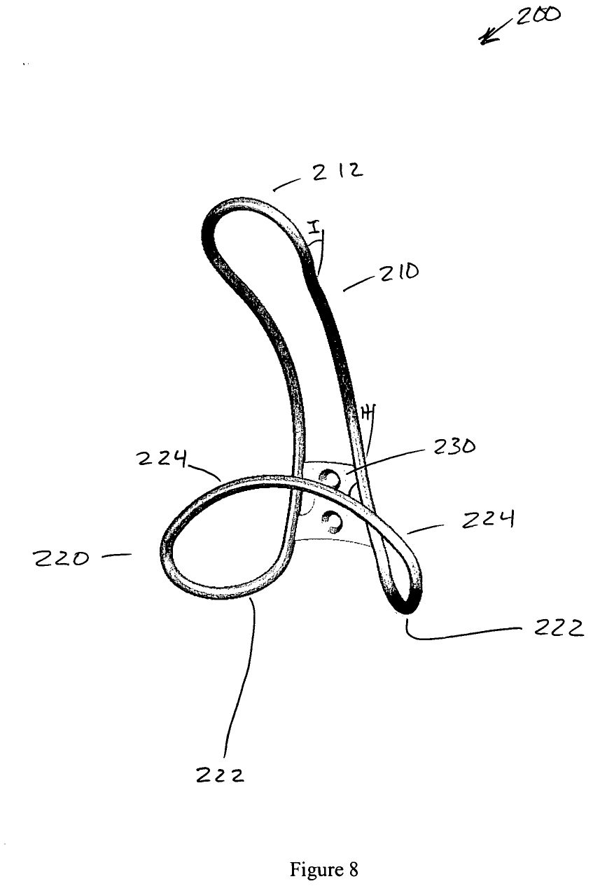

A further embodiment of the invention is illustrated in FIGS. 8 through 13. Similar to the garment hook 100 of FIG. 1, the garment hook 200 of FIG. 8 also provides a top hook 210, bottom hook 220 and base plate 230. According to this example embodiment, the top hook 210 extends upwardly at a first angle H with respect to the base plate. An end portion 212 of the top hook 210 forms an enlarged radius portion oriented at a second angle I with respect to the base plate.

The bottom hook 220 is formed by a second loop of wire and secured to the base plate 230. The bottom hook 220 forms a downwardly extending curved portion 222, coupled to an upwardly extending curved portion 224. The upwardly extending curved portion 224 has a width J at least twice a width dimension of the top hook K.

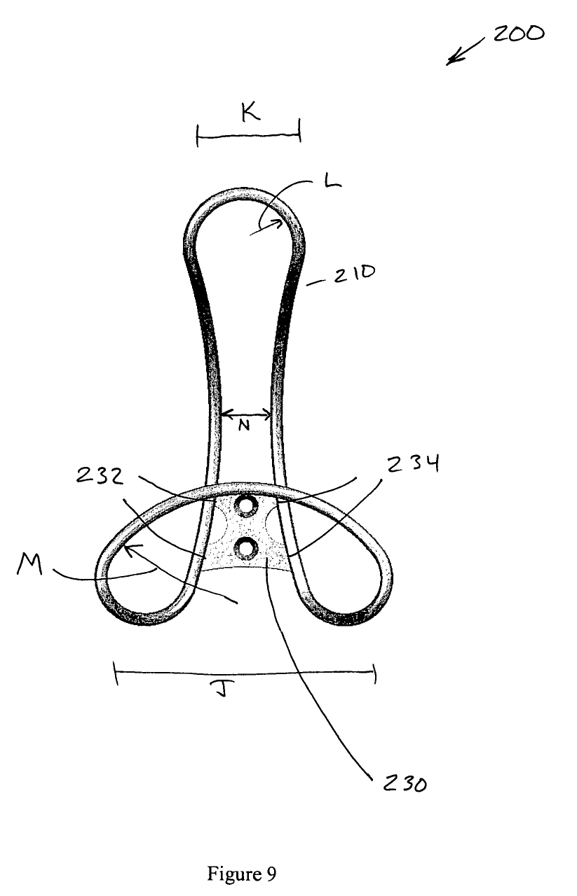

As with the garment hook 100 of FIG. 1, the garment hook 200 of FIG. 9 may have the top hook 210 and bottom hook 220 formed of a single, continuous wire. That single, continuous wire may include portions of the wire mounted to opposing edges 232, 234 of the base plate 230. As shown in FIG. 9, the base plate 230 may have non-parallel opposing edges 232, 234.

According to the illustrative embodiment, as shown in FIG. 9, the end portion 212 may have a radius smaller than a radius M of the upwardly extending curved portion 224 of the bottom hook 220. The top hook 110 may also be provided with a continuously variable width along its length with a minimum width N located away from an end of the top hook 110.

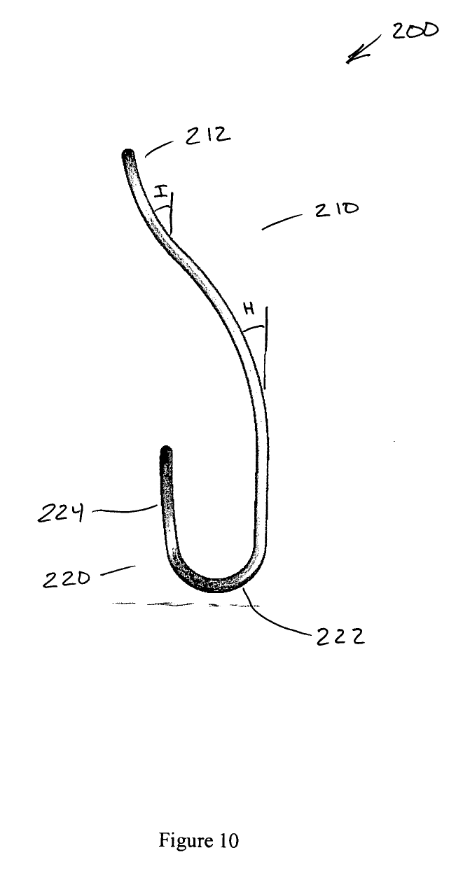

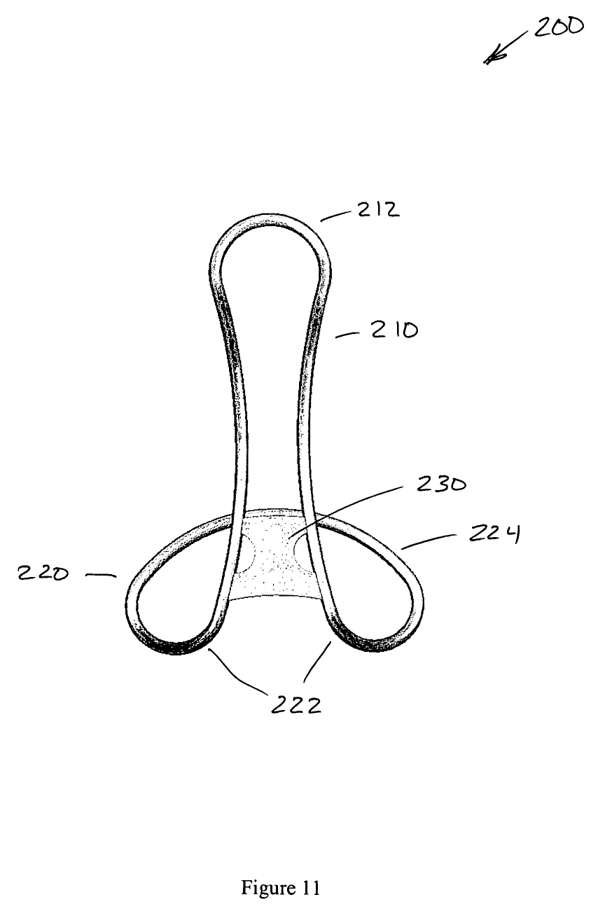

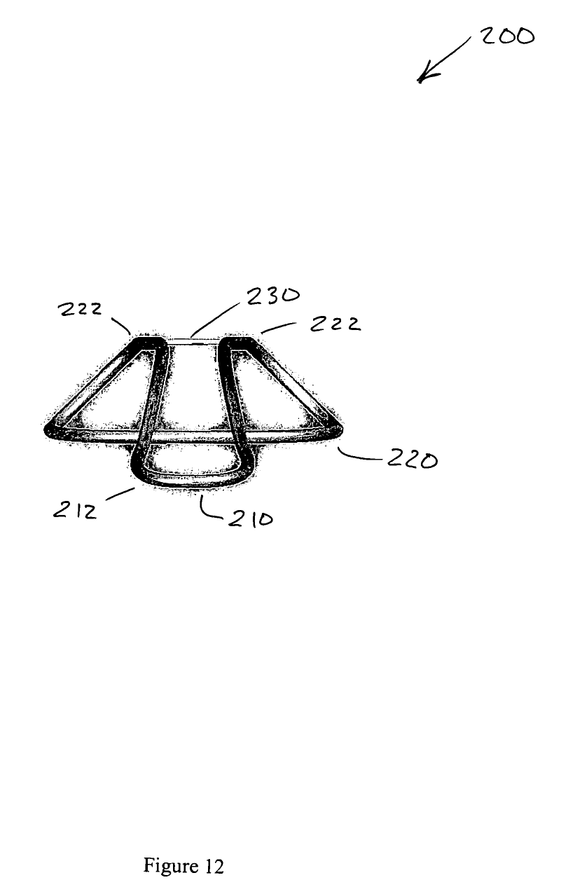

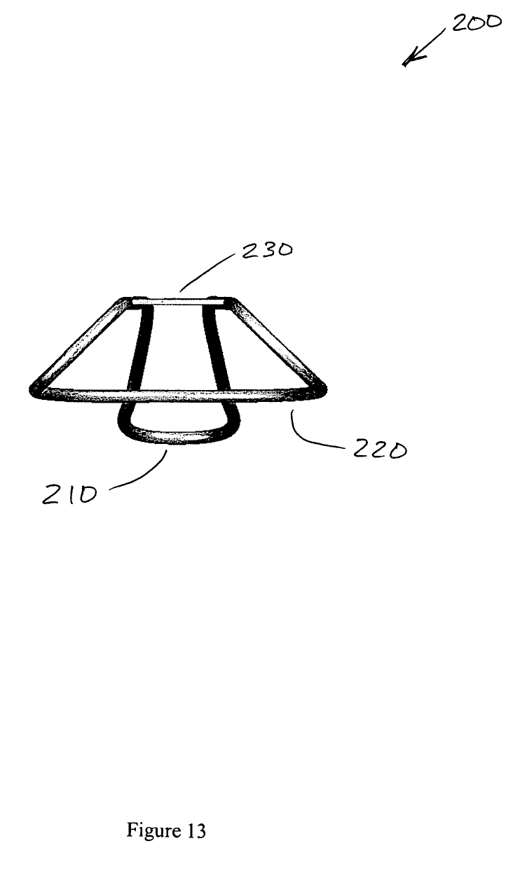

FIGS. 10 through 13 provide additional view of the garment hook 200. FIG. 10 illustrates a side view of the garment hook 210 while FIG. 11 provides a back view, FIG. 12 provides a top view and FIG. 13 provides a bottom view of the garment hook 200.

The approximate dimensions of the example embodiment of garment hook of FIGS. 8-13 are a center-to-center width of the bottom hook at 67 mm, with an outside width of 70 mm. The approximate top hook end portion 212 widths are 21 mm center-to-center and 24 mm outside width. An overall height is approximately 100 mm.

According to a further embodiment of the invention, a method of manufacturing a garment hook is provided. The method includes providing a base plate adapted to receive a fastener to secure the base plate to the wall. Also, formed from a single wire are a first loop and second loop. The first loop forms a top hook extending upwardly at a first angle with respect to the base plate. The second loop forms a bottom hook extending horizontally from the base plate and then forms and upwardly and outwardly extending curved portion, extending outwardly at a second angle relative to the base plate. The outwardly extending curved portion has a width dimension at least twice a width dimension of the top hook. The single wire is attached to the base plate. Optionally, a base plate cover may be provided to cover at least the portion of the base plate adapted to receive the fastener. Optionally, attaching the single wire to the base plate may include mounting the single wire to opposing edges of the base plate. It is also understood that methods of manufacture of the various garment hooks of the present invention are not limited to the method described above, and can include a wide variety of modifications including the use of more than a single wire in which to form the top hook and/or bottom hook, the use of casting, and the mounting of the base plate to one or more wires, including mounting the wires to other than opposing edges of the base plate.

The illustrative embodiments, implementations and examples herein are meant to be illustrative and not limiting. The present invention has been described by way of example, and modifications and variations of the exemplary embodiments will suggest themselves to skilled artisans in this field without departing from the spirit of the invention. Features and characteristics of the above-described embodiments may be used in combination. The preferred embodiments are merely illustrative and should not be considered restrictive in any way.

What is claimed is:

1. A garment hook, comprising:
a base plate adapted to receive a fastener to secure the base plate to a wall;
a top hook formed by a first loop of a wire and secured to the base plate, the top hook extending upwardly at a first angle with respect to the base plate, the top hook adapted to receive a hat or garment; and
a bottom hook formed by a second loop of a wire and secured to the base plate, the bottom hook having portions extending horizontally from the base plate and then forming an upwardly and outwardly extending curved portion, extending outwardly at a second angle relative to the base plate, the curved portion having a width dimension at least twice a width dimension of the top hook.

2. The garment hook of claim 1, wherein the portions of the bottom hook extending horizontally from the base plate extend away from the base plate in both an X and Y direction.

3. The garment hook of claim 1, wherein the base plate has a width equal to the width of the first loop

4. The garment hook of claim 1, wherein the first angle is substantially equal to the second angle.

5. The garment hook of claim 1, wherein the first loop of wire and the second loop of wire are formed of a single, continuous wire.

6. The garment hook of claim 5, wherein the single, continuous wire includes portions of the wire mounted to opposing edges of the base plate and extending between the first loop and the second loop.

7. The garment hook of claim 1, wherein the portion of the top hook extending upwardly at a first angle is longer than the portion of the bottom hook forming an upwardly and outwardly extending curved portion.

8. The garment hook of claim 7, wherein the portion of the top hook extending upwardly at a first angle is longer than the portion of the bottom hook extending horizontally from the base plate.

9. The garment hook of claim 1, wherein a radius of the portion of the top hook extending upwardly at a first angle is smaller than a radius of portion of the bottom hook forming an upwardly and outwardly extending curved portion.

10. The garment hook of claim 1, further comprising a cover positioned over the base plate.

11. A garment hook, comprising:
a base plate adapted to receive a fastener to secure the base plate to a wall;
a top hook formed by a first loop of a wire and secured to the base plate, the top hook extending upwardly at a first angle with respect to the base plate, an end portion of the top hook forming an enlarged radius portion oriented at a second angle with respect to the base plate, the top hook adapted to receive a hat or garment; and
a bottom hook formed by a second loop of a wire and secured to the base plate, the bottom hook forming a downwardly extending curved portion coupled to an upwardly extending curved portion, the upwardly extending curved portion having a width dimension at least twice a width dimension of the top hook.

12. The garment hook of claim 11, wherein the first loop of wire and the second loop of wire are formed of a single, continuous wire.

13. The garment hook of claim 12, wherein the single, continuous wire includes portions of the wire mounted to opposing edges of the base plate and extending between the first loop and the second loop.

14. The garment hook of claim 11, wherein the first loop of wire and second loop of wire are coupled to opposing edges of the base plate.

15. The garment hook of claim 14, wherein the opposing edges are non-parallel.

16. The garment hook of claim 11, wherein a radius of the end portion of the top hook is smaller than a radius of the upwardly extending curved portion of the bottom hook.

17. The garment hook of claim 11, wherein the first loop has a continuously variable width along its length, with a minimum width located away from an end of the first loop.

18. A method of manufacturing a garment hook, comprising:
providing a base plate adapted to receive a fastener to secure the base plate to a wall;
forming from a single wire:
a first loop forming a top hook extending upwardly at a first angle with respect to the base plate, the top hook adapted to receive a hat or garment;
a second loop forming a bottom hook extending horizontally from the base plate and then forming an upwardly and outwardly extending curved portion, extending outwardly at a second angle relative to the base plate, the upwardly extending curved portion having a width dimension at least twice a width dimension of the top hook; and attaching the single wire to the base plate.

19. The method of claim 18, further comprising providing a base plate cover to cover at least the portion of the base plate adapted to receive the fastener.

20. The method of claim 18, wherein the act of attaching the single wire to the base plate comprises mounting the single wire to opposing edges of the base plate.
